(19) United States
(12) Patent Application Publication
(10) Pub. No.: US 2004/0004548 A1
(43) Pub. Date: Jan. 8, 2004

(54) Electronic diaper

(76) Inventor: Chien-Tung Huang, Kuang-Fu Hsiang (TW)

Correspondence Address: CHIEN-TUNG HUANG, P.O. BOX 2-10, TAINAN CITY, TW

(21) Appl. No.: 10/191,845

(22) Filed: Jul. 4, 2002

(51) Int. Cl. G08B 23/00

(52) U.S. Cl. 340/573.5

(57) ABSTRACT

An electronic diaper includes a diaper, a sensor a controller, an LED lamp or a horn. The sensor senses dampness of a diaper and give a signal to the controller, which has a control circuit for calculating and converting the signal and gives out a warning signal to the LED lamp or the horn to give out light or sound for indicating that the diaper has become wet and needs to be replaced with a new one. And a timer may be further added to show the time of wetting of the diaper.

### BACKGROUND OF THE INVENTION

This invention relates to an electronic diaper, particularly to one able to give out a warning signal to remind a nurse that the diaper is wet and needs to be replaced with a new one.

Some of the conventional diapers on market are respectively provided with water-sensitive ink on its outer waterproof layer, which can sense dampness in the waterproof layer of a diaper and change its color for indicating that the diaper has become wet.

However, such a conventional diaper has the following defects.

1. Although the water-sensitive ink may change its color when the waterproof layer of a diaper becomes wet, yet the diaper has only one fine color-changing strip attached on its outer surface so the change of color of the color-changing strip can not be seen manifestly. In this case, a nurse usually has to take off a user's trousers first in order to check clearly if the change of color of the diaper happens, and decide whether it should be replaced or not. But sometimes a nurse may hardly recognize if the diaper becomes wet by observing the change of color of the color-changing strip in a dim room, causing much trouble and inconvenience.

2. Whether a diaper becomes wet or not is simply judged by observing the change of color of the color-changing strip, thus if a hires nurse pays no attention to it as he/she should do or even does not replace the wetted diaper intentionally, an employer can hardly find any specific evidence to prove that the nurse neglects his/her work on purpose.

3. The color-changing strip of a conventional diaper is liable to be influenced by the humidity in the air, that is, when there is too much humidity in air, the water-sensitive ink of the color-changing strip will sense the humidity and change its color, easily resulting in judging mistakenly.

### SUMMARY OF THE INVENTION

The objective of the invention is to offer an electronic diaper able to show the time of wetting of a diaper and give out warning signals such as light or sound to remind a nurse to replace the wet diaper with a new one, elevating a nurse's sense of duty and letting a user use the diaper with great comfort.

The features of the invention are as follows.

1. The electronic diaper is provided inside with a sensor (humidity sensor or two conductive wires), and the sensor is able to extend to the front side or the rear side of the diaper, having a plug connected with a controller.

2. The controller is installed inside the electronic diaper, having a control circuit to receive a signal coming from the sensor that the diaper has become wet. Then the controller calculates and converts the signal to be sent to an LED lamp or a horn to give out light or sound to remind a nurse that the diaper has become wet.

### BRIEF DESCRIPTION OF DRAWINGS

This invention will be better understood by referring to the accompanying drawings, wherein:

FIG. 1 is an exploded perspective view of a first embodiment of an electronic diaper in the present invention:

FIG. 2 is a perspective view of the first embodiment of the electronic diaper in the present invention:

FIG. 3 is a cross-sectional view of the electronic diaper in the present invention:

FIG. 4 is an exploded perspective view of a second embodiment of an electronic diaper in the present invention:

FIG. 5 is a diagram of the control circuit of a controller in the present invention.

### DETAILED DESCRIPTION OF THE PREFERRED EMBODIMENT

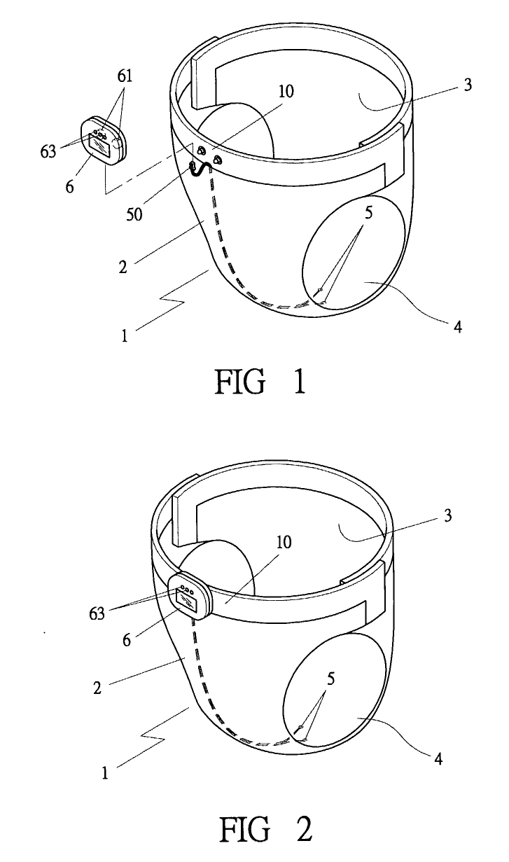

A preferred embodiment of an electronic diaper in the present invention, as shown in FIGS. 1, 2 and 3, includes a diaper 1, a sensor 5 and a controller 6 combined together.

The diaper 1 is provided with at least an upper and a lower dry layer 2 and 3, and between the upper and the lower dry layer 2 and 3 is sandwiched an absorbing layer 4. A sensor 5 (a humidity-sensing device or two conductive wires) is positioned between the upper dry layer 2 and the absorbing layer 4, or between the absorbing layer 4 and the lower dry layer 3.

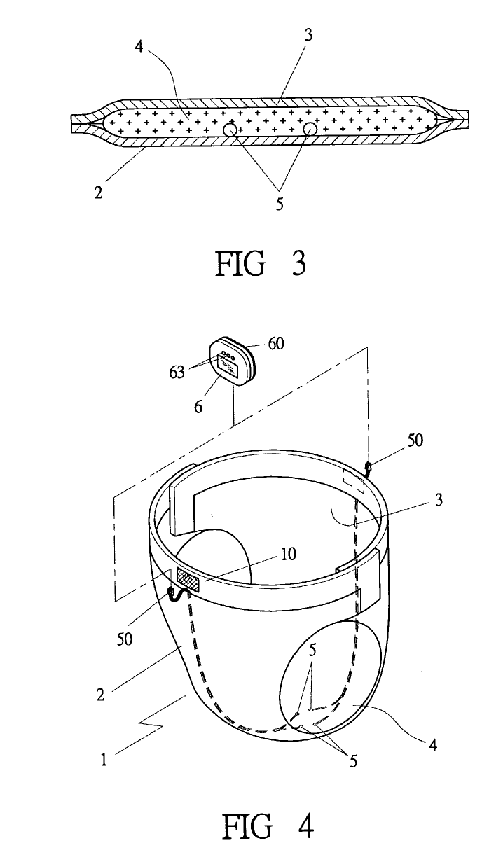

If the two conductive wires are employed as the sensor 5, they can be conducted by humidity. The sensor 5 can extend to the front side of a diaper, as shown in FIG. 3, or to the rear side or to both the front and the rear sides of the diaper, as shown in FIG. 4, depending on a user's posture of lying in bed. The sensor 5 further has a plug 50 connected with the controller 6. Thus, when the diaper 1 becomes wet, the controller 6 can be disconnected from the diaper 1 and employed repeatedly later on, while the used diaper 1 is thrown away.

Besides, whether the controller 6 is to be installed at the front portion or at the rear portion of the diaper 1 depends on practical needs and matches with the location of the plug 50.

In addition, a controller attaching sector 10 is provided at a front side or a rear side of a diaper, having a Velcro band 11 or a fastener 12 for attaching or pulling off the controller 6 conveniently.

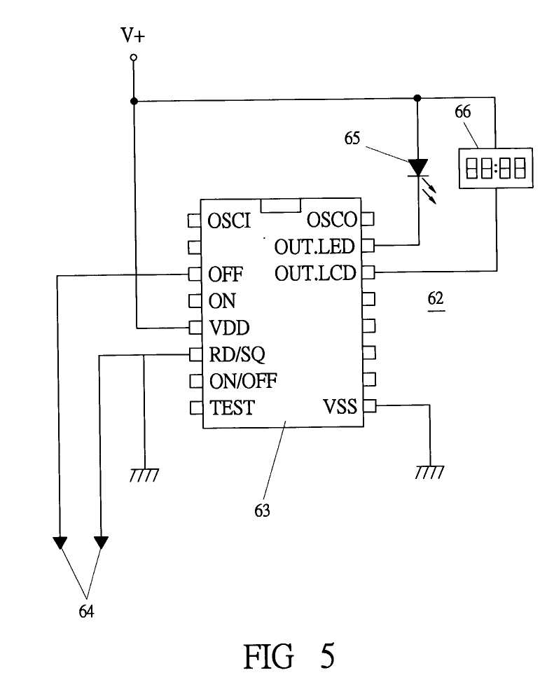

The controller 6 is provided with a Velcro band 60 or a fastener 61 to be combined with the Velcro band 11 or the fastener 12 of the diaper 1. The controller 6 is further installed inside with a control circuit 62 constructed of an integrated circuit 63 having a drive program burned inside, as shown in FIG. 5. The control circuit 62 has two adapters 64 connected with the sensor 5, so that signals coming from the sensor 5 can be calculated and converted by the control circuit 62 and then warning signals can be given out. The warning signal can be light given out by a LED lamp 65 or sound given out by a horn, and/or a timer 66 can be provided for indicating time of wetting of the diaper. Thus, when the diaper becomes wet but is not yet replaced, the horn will in due time give out sound to warn a nurse to renew the diaper, preventing a nurse from not replacing the diaper purposely, heightening a nurse's sense of duty and letting the user feel comfortable in using the electronic diaper.

While the preferred embodiment has been described above, it will be recognized and understood that various modifications may be made therein and the appended claims are intended to cover all such modifications that may fall within the spirit and scope of the invention.

What is claimed is:

1. An electronic diaper comprising a diaper provided with at least an upper dry layer and a lower dry layer, an absorbing layer sandwiched between said upper and said lower dry layer, a sensor installed between said upper dry layer and said absorbing layer, or between said absorbing layer and said lower dry layer, and a humidity-sensing device employed as said sensor for sensing the condition of said diaper.

2. The electronic diaper as claimed in claim 1, wherein two conductors are employed as said sensor.

3. An electronic diaper comprising:
A diaper provided with at least an upper dry layer and a lower dry layer, an absorbing layer sandwiched between said upper and said lower dry layer:
A sensor positioned between said upper dry layer and said absorbing layer or between said damp-absorbing layer and said lower dry layer of said diaper, said sensor being a humidity-sensing device for sensing the condition of said diaper, said sensor able to extend to the front or the rear portion, or to both the front and the rear portions of said diaper, said sensor having a plug connected with a controller:
A controller attaching sector provided at a front or a rear side of said diaper, said controller attaching sector provided with a Velcro band or a fastener, said Velcro band or said fastener for attaching or pulling off said controller conveniently:
Said controller provided with a Velcro band or a fastener, said Velcro band or said fastener of said controller combined with said Velcro band or said fastener of said controller attaching sector, said controller installed inside with a control circuit constructed of an integrated circuit, said control circuit having two adapters connected with said sensor, said control circuit calculating and converting signals coming from said sensor and giving out warning signals.

4. The electronic diaper as claimed in claim 3, wherein said warning signal is converted into light by a LED lamp.

5. The electronic diaper as claimed in claim 3, wherein said warning signal is converted into sound by a horn.

6. The electronic diaper as claimed in claim 4, wherein a timer is further coupled with said LED lamp for indicating time of wetting of said diaper.

7. The electronic diaper as claimed in claim 5, wherein a timer is further coupled with said horn for indicating time of wetting of said diaper.
